(19) United States
(12) Patent Application Publication
(10) Pub. No.: US 2019/0205880 A1
(43) Pub. Date: Jul. 4, 2019

(54) SYSTEMS AND METHODS FOR VALIDATING PAYMENT TRANSACTIONS

(71) Applicant: Mastercard International Incorporated, Purchase, NY (US)

(72) Inventors: Christopher Vernon, Cottleville, MO (US); David J. Senci, Troy, IL (US); Kyle Williams, Wentzville, MO (US)

(73) Assignee: Mastercard International Incorporated, Purchase, NY (US)

(21) Appl. No.: 15/861,847

(22) Filed: Jan. 4, 2018

(51) Int. Cl. G06Q 20/40; G06Q 20/38

(52) U.S. Cl. CPC G06Q 20/405; G06Q 20/382; G06Q 20/401

(57) ABSTRACT

A computer-implemented method for verifying a payment transaction over a payment network. One step of the method includes receiving, from a sender, a transaction message, with the transaction message including a plurality of data element fields, and with at least one of the data element fields being a network-specific field configured to be populated by an interchange network of the payment network. An additional step includes performing a validation routine on the transaction message. The validation routine includes analyzing the network-specific field of the transaction message to determine if the network-specific field is populated with data. A further step includes transmitting a financial transaction denial to the sender if the network-specific field of the transaction message is populated with data.

### FIELD OF THE DISCLOSURE

The field of the disclosure relates generally to systems and methods for validating payment transactions and, more particularly, to network-based systems and methods for analyzing network-specific fields in transaction messages associated with payment transactions and validating such payment transactions based on the analyses.

### BACKGROUND OF THE DISCLOSURE

The use of credit and/or debit cards for payment transactions is now commonplace. Unfortunately, at least some of such payment transactions involve fraudulent activity. Fraudulent payment transactions present liability concerns to one or more network-based parties involved in the payment transactions, such as an issuing bank, an acquiring bank, a merchant, a payment processing network, and/or the like. As such, these parties are interested in fraud-detection procedures, or the ability to analyze the data surrounding payment transactions so as to validate the payment transactions before final authorization of the payment transactions occur.

One previously-used fraud-detection procedure is cardholder authentication, in which interchange networks implement (or engage with) an authentication service platform that performs an authentication of a cardholder prior to authorization of a payment transaction initiated by such cardholder. The authentication service platform determines if the source of the payment transaction is the authorized cardholder of the payment card. If the source of the payment transaction is not the authorized cardholder, then the payment transaction may be declined. In addition to cardholder authentication, other previously-used fraud-detection procedures include the use of a fraud-scoring system to detect potentially-fraudulent payment transactions. For example, some fraud-detection processes may analyze information related to payment transactions so as to determine if any of such information is indicative of fraud. If fraud (or potential fraud) is detected, then the payment transaction may be declined.

However, such above-described fraud-detection procedures have drawbacks because they can miss or overlook certain fraudulent payment transactions, or, alternatively, they can improperly reject valid payment transactions as being fraudulent (i.e., generate false positives). Furthermore, fraudulent actors have been known to manipulate transaction messages, which are generated in association with payment transactions, so as to make the payment transactions appear valid, even if such payment transactions are fraudulent. For example, fraudulent actors may improperly populate certain network-specific fields included within transaction messages, which can cause potentially-fraudulent transactions to be missed by previously-used fraud-detection procedures.

### BRIEF DESCRIPTION OF THE DISCLOSURE

This summary is not intended to identify essential features of the present invention, and is not intended to be used to limit the scope of the claims. These and other aspects of the present invention are described below in greater detail.

In one aspect, a financial transaction verification system for a payment network is provided. The financial transaction verification system includes a memory device for storing data, and a processor communicatively coupled to the memory device. The processor is programmed to receive, from a sender, a transaction message associated with a financial transaction. The transaction message comprises a plurality of data element fields. At least one of the data element fields is a network-specific field configured to be populated by an interchange network of the payment network. The processor is further programmed to perform a validation routine on the transaction message, with the validation routine including analyzing the network-specific field of the transaction message to determine if the network-specific field is populated with data. The processor is further configured to (1) deny the financial transaction by transmitting a denial message to the sender if the network-specific field of the transaction message is populated with data, or (2) validate the financial transaction by transmitting the transaction message to an issuer associated with the financial transaction if the network-specific field of the transaction message is not populated with data.

In another aspect, a computer-implemented method for verifying a financial transaction conducted over a payment network is provided. The method comprises the step of receiving, from a sender, a transaction message associated with a financial transaction. The transaction message comprises a plurality of data element fields, with at least one of the data element fields being a network-specific field configured to be populated by an interchange network of the payment network. The method additionally comprises the step of performing a validation routine on the transaction message, with the validation routine including analyzing the network-specific field of the transaction message to determine if the network-specific field is populated with data. The method further comprises (1) denying the financial transaction by transmitting a denial message to the sender if the network-specific field of the transaction message is populated with data, or (2) validating the financial transaction by transmitting the transaction message to an issuer associated with the financial transaction if the network-specific field of the transaction message is not populated with data.

In yet another aspect, embodiments provide for one or more non-transitory computer-readable storage media having computer-executable instructions for verifying a financial transaction conducted over a payment network stored thereon. When executed by at least one processor, the computer-executable instructions cause the processor to perform a number of steps. One step includes receiving, from a sender, a transaction message associated with a financial transaction. The transaction message comprises a plurality of data element fields, and at least one of the data element fields is a network-specific field configured to be populated by an interchange network of the payment network. An additional step includes performing a validation routine on the transaction message, with the validation routine including analyzing the network-specific field of the transaction message to determine if the network-specific field is populated with data. A further step includes (1) denying the financial transaction by transmitting a denial message to the sender if the network-specific field of the transaction message is populated with data, or (2) validating the financial transaction by transmitting the transaction message to an issuer associated with the financial transaction if the network-specific field of the transaction message is not populated with data.

### BRIEF DESCRIPTION OF THE DRAWINGS

Embodiments of the present invention are described in detail below with reference to the attached drawing figures, wherein:

FIG. 1 is a block diagram of an exemplary multi-party payment network system having a payment transaction validation module (PTV module) according to embodiments of the present invention;

FIG. 2 is another block diagram of an exemplary payment card network system, such as the payment card network system shown in FIG. 1, including a plurality of client computing systems connected to a server system of an interchange network, and with the PTV module from FIG. 1 illustrated in association with the server system;

FIG. 3 illustrates an exemplary configuration of the server system shown in FIG. 2;

FIG. 4 illustrates an exemplary configuration of a client computing system from FIG. 2;

FIG. 5 is a data flow diagram illustrating transaction messages being transmitted between a sender, an issuer, and an interchange network, and further illustrating a payment transaction validation module (PTV module) of the interchange network configured to validate a payment transaction associated with the transaction messages;

FIG. 6A is a first portion of a flow chart of an exemplary method for validating a payment transaction; and

FIG. 6B is a second portion of the exemplary method, the first portion of which is shown in FIG. 6A.

The figures are not intended to limit the present invention to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to validating payment transactions made using payment network systems. However, the scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, operation, etc. described in one embodiment may also be included in other embodiments, but is not necessarily included. Thus, particular implementations of the present invention can include a variety of combinations and/or integrations of the embodiments described herein.

Broadly characterized, the present invention relates to systems and methods for validating payment transactions. More particularly, the disclosed embodiments provide systems and computer-implemented method for validating a network-based payment transaction. In one exemplary embodiment, a payment transaction validation (PTV) module for validating payment transactions may be configured for use with a payment-card processing network such as, for example, an interchange network. The PTV module may comprise a memory device and a processing element in communication with the memory device. As such, the PTV module is configured to work in association with and/or to communicate with the interchange network for purposes of receiving and analyzing transaction messages generated in association with payment transactions. The PTV module may be configured to analyze specific fields within the transaction message, and based on such analyses, validate whether the corresponding payment transaction is an authorized transaction or a fraudulent transaction. For those payment transactions that are determined to be fraudulent (or potentially fraudulent), the interchange network may deny the payment transactions.

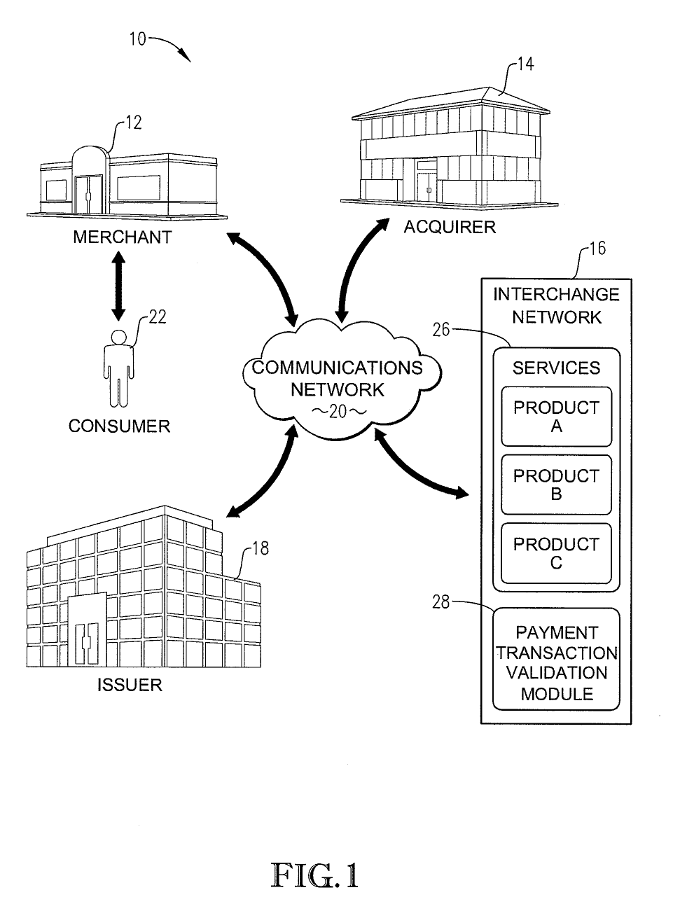

Turning now to the system for implementing embodiments of the present invention, FIG. 1 is a block diagram of an exemplary multi-party payment network system 10. In general, the payment network system 10 is configured to enable payment transactions, such as payment-by-card transactions, through operation of a number of interconnected parties, including merchants 12, acquirers 14, interchange networks 16, and/or card issuers 18. Embodiments described herein may relate to a payment network system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. Mastercard is a registered trademark of Mastercard International Incorporated located in Purchase, N.Y.

As used herein, financial transaction data may include transaction messages, which are unique data messages that include information related to payment transactions initiated via payment cards (e.g., credit or debit cards). In some embodiments, as will be described in more detail below, transaction messages may be formatted according to one or more commonly-used standards, such as the ISO 8583 standard format. Broadly, a transaction message may include data fields populated with various types of data or information related to a payment transaction made with a payment card. For example, such data may include (1) an account or card number associated with the payment card, and (2) purchase data representative of the payment transaction, e.g., a type of merchant, amount of purchase, date of purchase, and the like. As will be described in more detail below, the transaction messages for a given payment transaction may be transmitted between the various parties of the payment network system 10 for purposes of validating the payment transaction and settling of funds related to the payment transaction.

As noted above, in the exemplary embodiment of FIG. 1, the payment network system 10 may generally include the merchant 12, the acquirer 14, the interchange network 16, and the issuer 18, coupled in communication via a communications network 20. As such, a cardholder 22 (e.g., a consumer), who is an authorized user of a payment card, can initiate a payment transaction over the payment network system 10 to make a purchase from a merchant 12. The communications network 20 used to interconnect the parties of the payment network system 10 may include various types of networks, such as one or more of a local area network (LAN), a wide area network (WAN) (e.g., the Internet, etc.), a mobile network, a virtual network, and/or any other suitable public and/or private network capable of facilitating communication among the merchant 12, the acquirer 14, the interchange network 16, and/or the issuer 18. In some embodiments, the communications network 20 may include more than one type of network, such as a private payment transaction network provided by the interchange network 16 to the acquirers 14 and the issuers 18 and, separately, the public Internet, which may facilitate communication between the merchants 12 and (1) the interchange network 16, (2) the acquirers 14, and/or (3) the cardholder 22.

The payment network system 10 may facilitate payment transactions made by the cardholder 22. In typical systems, a financial institution, referred to as an “issuing bank” or the issuer 18, issues a payment card, such as a credit or debit card, to a cardholder 22, who uses the payment card to tender payment for purchases made from a merchant 12. Merchants 12 are typically associated with products, for example, and without limitation, goods and/or services, that are offered for sale and are sold to the cardholder 22. The merchant 12 may include, for example, a physical location and/or a virtual location. A physical location includes, for example, a brick-and-mortar store, etc., and a virtual location includes, for example, an Internet-based store-front.

To accept payment with the payment card, the merchant 12 generally has established an account with a financial institution that is part of the payment network system 10. This financial institution is generally referred to as a “merchant bank,” an “acquiring bank,” or the acquirer 14. When the cardholder 22 tenders payment for a purchase with a payment card, the merchant 12 requests authorization from the acquirer 14 for the amount of the purchase. The request may be performed over the telephone, but is usually performed through the use of a computing device, such as point-of-sale terminal, that reads the cardholder's 22 account information from a magnetic stripe, a chip, or embossed characters on the payment card and generates a transaction message, in the form of an authorization request, which is communicated electronically to transaction processing computers of the acquirer 14. Alternatively, the acquirer 14 may authorize a third party to perform transaction processing on its behalf. In such cases, the merchant's 12 point-of-sale terminal will be configured to communicate with the third party. Such a third party is generally referred to as a “merchant processor,” an “acquiring processor,” or a “third-party processor.”

Using the interchange network 16, computing devices of the acquirer 14 or merchant processor can communicate with computing devices of the issuer 18 to determine whether the cardholder's 22 account is in good standing and whether the purchase is covered by the cardholder's 22 available credit line or account balance. Again, such communication generally involves the interchange network 16 providing the transaction message to the issuer 18, such that the issuer 18 can verify that the cardholder's 22 account has sufficient funds to cover the payment transaction. Based on these determinations, the payment transaction can be declined or accepted. Specifically, the issuer 18 can generate a transaction message, in the form of an authorization response, which indicates whether the payment transaction should be declined or accepted. The transaction message can be sent from the issuer 18, via the interchange network 16 and/or the acquirer 14, to the merchant 12 such that the cardholder 22 can be informed as to whether the payment transaction is declined or accepted.

When a request for authorization of the payment transaction is accepted, the available credit line or account balance of the cardholder's 22 account is decreased. Normally, a charge for an online payment card transaction is not posted immediately to the cardholder's 22 account because bankcard associations, such as Mastercard International Incorporated, have promulgated rules that do not allow the merchant 12 to charge, or “capture,” a payment transaction until the purchased goods are shipped or the purchased services are delivered. However, with respect to at least some debit card transactions, a charge may be posted at the time of the payment transaction. When the merchant 12 ships or delivers the goods or services, the merchant 12 captures the payment transaction by, for example, appropriate data entry procedures on the point-of-sale terminal. This may include bundling of approved transactions daily for standard retail purchases. If the cardholder 22 cancels a payment transaction before it is captured, a “void” is generated. If the cardholder 22 returns goods after the transaction has been captured, a “credit” is generated. For debit card transactions, when a request for a personal identification number (PIN) authorization is requested and is approved by the issuer 18, the cardholder's 22 account is decreased. Normally, a charge is posted immediately to the cardholder's account. The interchange network 16 transmits the approval to the acquirer 14 for distribution of goods/services or information, or cash in the case of an automated teller machine (ATM).

After a purchase has been made, a clearing process occurs to transfer additional financial transaction data related to the purchase transaction among the parties of the payment network system 10, such as the acquirer 14, the interchange network 16, and the issuer 18. More specifically, during and/or after the clearing process, additional financial transaction data, such as a time of purchase, a merchant name, a type of merchant, purchase information, cardholder account information, a type of transaction, itinerary information, information regarding the purchased item and/or service, and/or other suitable information, may be associated with the payment transaction and transmitted between parties to the payment transaction, and may be stored (e.g., in databases) by any of the parties.

After a payment transaction is authorized and cleared, the payment transaction is settled among the merchant 12, the acquirer 14, and the issuer 18. Settlement refers to the transfer of financial transaction data and/or funds among the merchant's 12 account, the acquirer 14, and the issuer 18 related to the transaction. Usually, payment transactions are captured and accumulated into a “batch,” which is settled as a group. More specifically, a payment transaction is typically settled between the issuer 18 and the interchange network 16, and then between the interchange network 16 and the acquirer 14, and then between the acquirer 14 and the merchant 12.

With continued reference to FIG. 1, the interchange network 16 is generally used to facilitate communication and financial transaction data processing between the parties of the payment network system 10. In addition, however, the interchange network 16 may be configured to offer or provide one or more services 26 (e.g., Product A, Product B, Product C, etc.) to one or more of its clients, which may include the merchants 12, the acquirer 14, the issuer 18, and/or the cardholder 22. The services may be referred to as value-added services 26, for example, in that the services are often provided in addition to the standard interchange network 16 goal of coordinating payment transactions initiated by the cardholders 22. Exemplary services include, for example and without limitation, fraud services (e.g., fraud detection, fraud scoring, etc.), loyalty services (e.g., managing reward points, etc.), account control services (e.g., transaction limits, etc.), authentication services, routing intelligence services, message transformation services (e.g., format and/or standard conversions, etc.), services for applying additional derived data and/or insights to transaction messages, identification of other value added services to be applied, etc.

Embodiments of the present invention provide for the interchange network 16 to be configured to offer or provide a specific value-added service 26, in the form of a fraud-detection service, which can be used to validate payment transactions. This fraud-detection service for validating payment transactions may be implemented by a payment transaction verification (PTV) module 28, which is illustrated schematically as part of the interchange network 16 of FIG. 1. The PTV module 28 may be configured as a specially-programmed computer system that enables the interchange network 16 to implement an automated process or routine to analyze transaction messages (e.g., authorization messages or response messages) resulting from a cardholder 22 initiating a payment transaction. Based on the PTV module's 28 analyses of transaction messages, payment transactions can be authorized or denied/declined. As will be described in more detail below, the PTV module 28 may comprise a computing device in the form of one or more processing elements communicatively coupled with one or memory elements with a computer program stored thereon (e.g., a computer-readable storage media or medium comprising a non-transitory medium with an executable computer program stored thereon), such that the PTV module 28 can be specially programmed to (1) receive transaction messages associated with payment transactions, (2) analyze one or more fields included within the transaction messages, and (3) validate the payment transactions based on such analyses, such that the payment transactions can be authorized or denied.

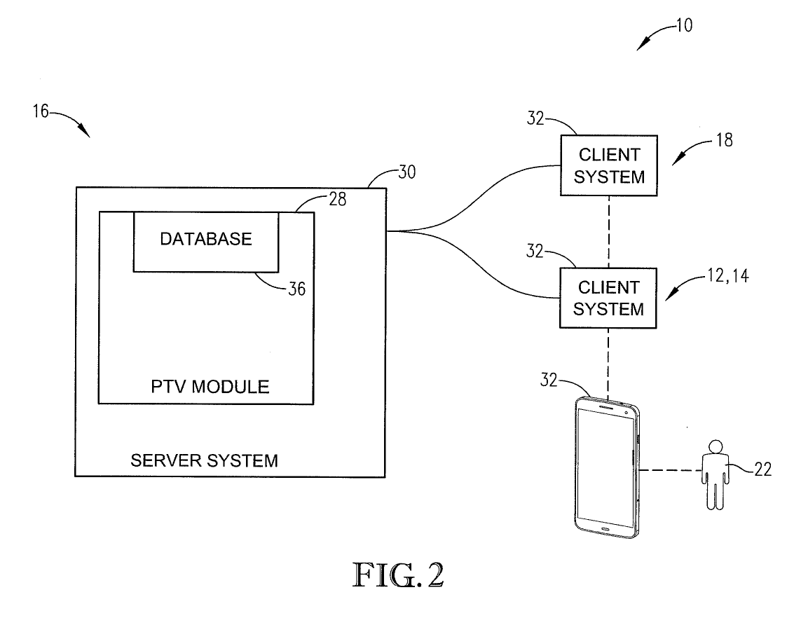

FIG. 2 is another simplified block diagram of the exemplary payment network system 10. The block diagram of FIG. 2 may be considered an alternate description of the components of the payment network system 10 described above. The payment network system 10 of FIG. 2 includes a plurality of computing devices such as, for example, the PTV module 28, a server system 30, and one or more client systems 32 all connected via a communications network, such as the Internet. The server system 30 may comprise a server-type computing device of the interchange network 16, which is particularly configured to perform various functions and features described herein on behalf of the interchange network 16. Similarly, the PTV module 28 may comprise a computing device of the interchange network 16, which is particularly configured to validate payment transactions initiated at a merchant 12. In some embodiments, the PTV module 28 may be incorporated within the server system 30. In alternate embodiments, the PTV module 28 may be separate from the server system 30. In contrast, the client systems 32 may be computing devices of clients, such as the merchant 12, the acquirer 14, the issuer 18, and/or the cardholder 22, which are in communication with the server system 30 via the communications network. It is noted that the payment network system 10 may include more, fewer, or alternative components and/or perform more, fewer, or alternative actions, including those discussed elsewhere herein.

In more detail, the server system 30 may be associated with the interchange network 16, and may be referred to as an interchange computer system. Broadly, the server system 30 may be used for processing financial transaction data associated with payment transactions. In some embodiments, the server system 30 may include, or otherwise be associated with a database 36, which is configured to store information about a variety of matters, such as may be necessary for processing financial transaction data. In some embodiments, the database 36 may comprise a centralized database stored on the server system 30. In some embodiments, the database 36 may be associated with the PTV module 28. In an alternative embodiment, the database 36 may be stored remotely from the server system 30 and/or the PTV module 28, such as in the form of a distributed or non-centralized database. In one exemplary embodiment, the database 36 may include a single database having separated sections or partitions or may include multiple databases, each being separate from each other. In some embodiments, for example, where the database 36 includes separate sections, partitions, or multiple databases, the database 36 may be configured to store financial transaction data generated as part of payment transactions conducted over the payment network system 10 including data relating to cardholders 22, issuers 18, acquirers 14, and/or payment transactions.

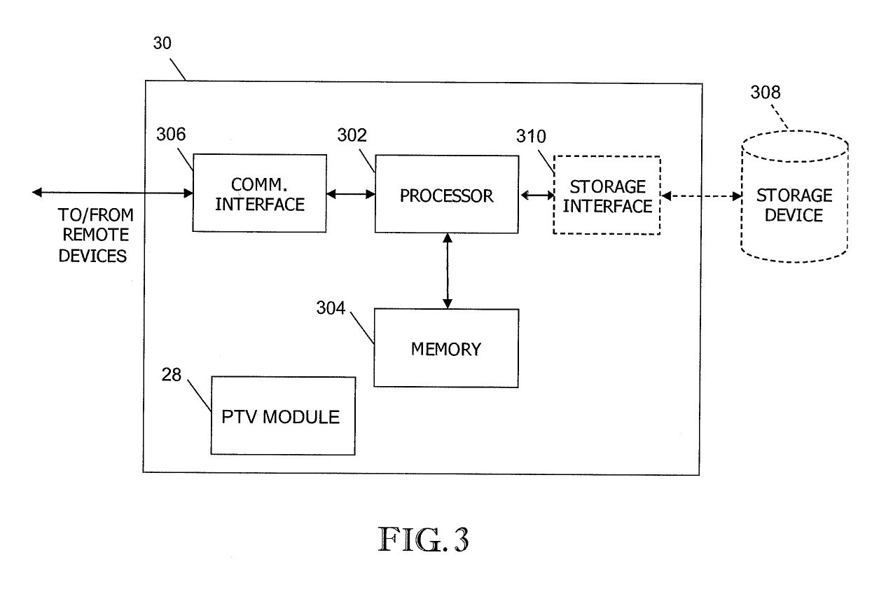

FIG. 3 illustrates an exemplary configuration of the server system 30 in more detail. In the exemplary embodiment, the server system 30 may include, for example, and without limitation, the server 36 and the PTV module 28. The server system 30 may additionally include one or more processors 302 for executing instructions, processes, code segments, routines, or the like, which may be stored in a memory 304. The processor 302 may include one or more processing units (e.g., in a multi-core configuration) for executing instructions. The instructions may be executed within a variety of different operating systems on the server system 30, such as UNIX, LINUX, Microsoft Windows®, etc. It should also be appreciated that upon initiation of a computer-implemented method, various instructions may be executed during initialization. Some operations may be required in order to perform one or more processes described herein, while other operations may be more general and/or specific to a particular programming language (e.g., C, C#, C++, Java, or other suitable programming languages, etc.).

The memory 304 of the server system 30 may be communicatively coupled with the processor 302 and may include, for example, and without limitation, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

The processor 302 may be operatively coupled to a communication interface 306 such that the server system 30 is capable of communicating with a remote device such as a client system 32 or another server system 30. For example, the communication interface 306 may communicate with the client systems 32 via the Internet. The processor 302 may also be operatively coupled to a storage device 308. The storage device 308 may comprise any computer-operated hardware suitable for storing and/or retrieving data. In certain embodiments, the storage device 308 may provide or make available the database 36, described above, which can be used by the sever system 30. In some embodiments, the storage device 308 may be integrated in the server system 30 and/or in the PTV module 28. For example, the server system 30 may include one or more hard disk drives that comprise the storage device 308. In other embodiments, the storage device 308 may be external to the server system 30 and may be accessed by the server systems 30 via a storage interface 310 described in more detail below. The storage device 308 may include multiple storage units such as hard disks or solid-state disks in a redundant array of inexpensive disks (RAID) configuration. The storage device 308 may include a storage area network (SAN) and/or a network attached storage (NAS) system.

As noted, the processor 302 may be operatively coupled to the storage device 308 via the storage interface 310. The storage interface 310 may comprise any component capable of providing the processor 302 with access to the storage device 308. The storage interface 310 may include, for example, and without limitation, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 308.

Embodiments provide for the PTV module 28 to be a component of the server system 30 or, alternatively, to be a separate computing device. As such, the PTV module 28 can be used, as will be described in more detail below, to perform routines for validating payment transactions by analyzing transaction messages generated in response to initiated payment transactions. In embodiments in which the PTV module 28 is incorporated within the server system 30, the PTV module 28 may be a specifically-programmed section of the server system 30. As such, the PTV module 28 may use the processor 302, the memory 304, the communications interface 306, and/or the storage device 308 of the server system 30. In alternate embodiments, the PTV module 28 may be a separate computing device (which may be communicatively coupled with) the server system 30. In such embodiments, the PTV module 28 may include its own processor, memory, communications interface, and/or the storage device, similar to those components described above with respect to the server system 30. In such embodiments, for example, the PTV module 28 may be independently associated with the interchange network 16 or with an outside third party in a contractual relationship with the interchange network 16.

Returning to FIG. 2, the client systems 32 may include various computer systems associated with the merchant 12 and/or acquirer 14 (shown in FIG. 1), as well as the issuer 18 (also shown in FIG. 1). Another client system 32 may be a computing device associated with a cardholder 22. It should be understood, however, the client systems 32 may be computer systems associated with other entities, such as online banks, bill payment outsourcers, processors, billers, or another entity associated with the payment network system 10.

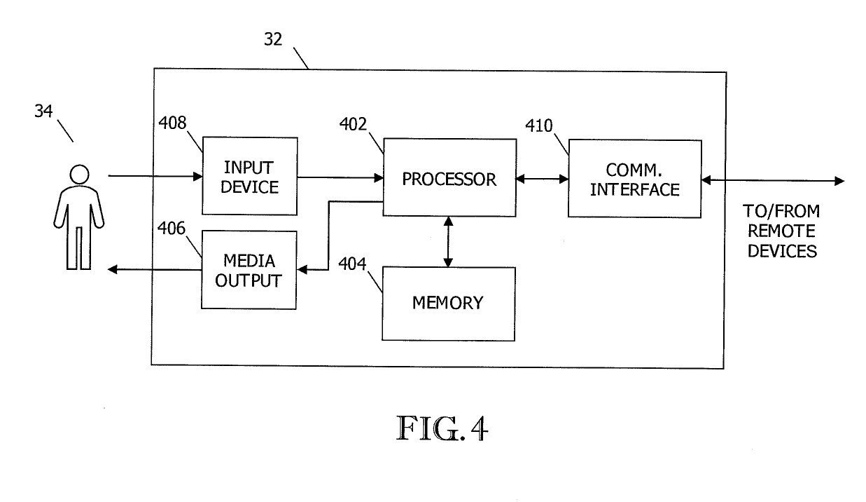

FIG. 4 illustrates an exemplary configuration of a client system 32. In the example embodiment, the client system 32 may include one or more processors 402 for executing instructions, processes, code segments, routines, or the like, which may be stored in a memory 404. The processor 402 may include one or more processing units, for example, a multi-core configuration. The memory 404 is any device allowing information such as executable instructions and/or other data to be stored and retrieved. The memory 404 may include one or more computer readable media.

The client system 32 may also include at least one media output component 406 for presenting information to users. The media output component 406 is any component capable of conveying information to an authorized user 34. In some embodiments, the media output component 406 includes an output adapter such as a video adapter and/or an audio adapter. An output adapter is operatively coupled to the processor 402 and operatively couplable to an output device such as a display device, a liquid crystal display (LCD), organic light emitting diode (OLED) display, or “electronic ink” display, or an audio output device, a speaker, or headphones.

In some embodiments, the client system 32 includes an input device 408 for receiving input from the user 34. The input device 408 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of the media output component 406 and the input device 408. The client system 32 may also include a communication interface 410, which is communicatively couplable to a remote device such as the server system 30. The communication interface 410 may include, for example, a wired or wireless network adapter or a wireless data transceiver for use with a mobile phone network, Global System for Mobile communications (GSM), 3G, 4G or Bluetooth or other mobile data network or Worldwide Interoperability for Microwave Access (WIMAX).

Stored in the memory area 404 are, for example, computer readable instructions for providing a user interface to the user 34 via the media output component 406 and, optionally, receiving and processing input from the input device 408. A user interface may include, among other possibilities, a web browser and a client application. Web browsers enable users, such as authorized user 34, to display and interact with media and other information typically embedded in remote applications, web pages, or websites.

The memory area 404 may include, for example, and without limitation, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

Given the components of the payment network system 10 described above, embodiments of the present invention are configured to validate payment transactions by analyzing transaction messages associated with such payment transactions. As previously noted, fraudulent actors have been known to generate fraudulent transaction messages and/or to modify valid transaction messages with fraudulent data. Such fraudulent or improperly-modified transaction messages can be used to authorize fraudulent payment transactions. To combat such scenarios, embodiments of the present invention, and particularly the PTV module 28, is specially configured to analyze transaction messages so as to determine the validity of associated payment transactions.

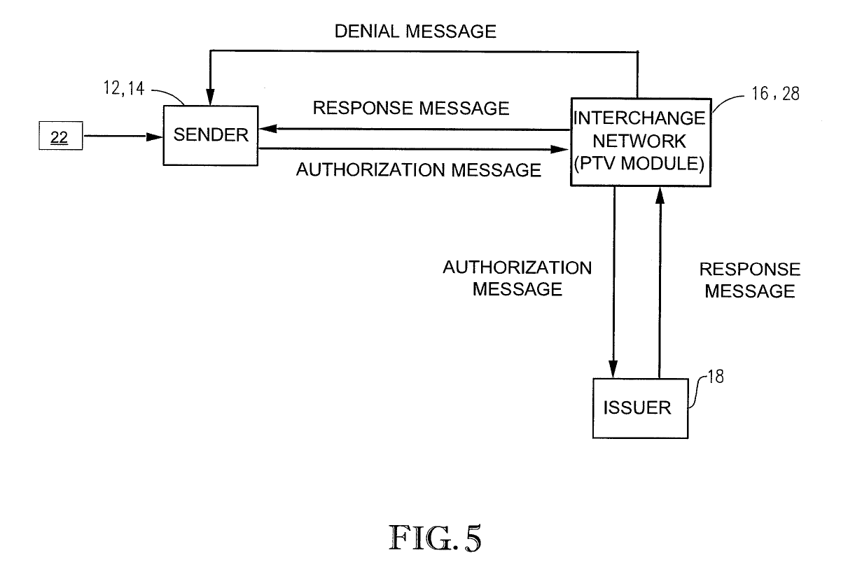

FIG. 5 broadly illustrates a schematic diagram of the flow of transaction messages generated in response to an initiated payment transaction. As will be described in more detail below, the interchange network 16, and specifically the PTV module 28 of the interchange network 16, can analyze the transaction messages and, thereby, validate the associated payment transaction. To begin, a sender, which may include the merchant 12 and/or the acquirer 14 can generate and send a transaction message (in the form of an authorization message) to the interchange network 16 in response to a cardholder 22 initiating a payment transaction at the merchant 12. Upon the authorization message being received at the interchange network 16, the PTV module 28 is configured to analyze the authorization message to determine whether one more network-specific fields within the authorization message have been improperly populated. As will be described in more detail below, certain fields within transaction messages are configured to be populated only by the interchange network 16 (herein referred to as “network-specific fields”). If the PTV module 28 determines that one or more of such network-specific fields of the authorization message has been improperly populated (e.g., pre-populated), the interchange network 16 may send a payment transaction denial message, such as a data format error message, back to the sender (e.g., the merchant 12) indicating that the payment transaction should be denied/declined.

If the PTV module 28 determines that the one or more network-specific fields of the authorization message has not been improperly populated, the interchange network 16, e.g., via the PTV module 28, may populate such network-specific fields with specific data elements (i.e., data values) and forward the authorization message on to the issuer 18. The issuer 18 will determine whether the cardholder 22 has sufficient credit or funds in the cardholder's 22 account to satisfy the payment transaction and will generate and send a responsive transaction message (e.g., a response message) back to the interchange network 16. Once the response message is received by the interchange network, the PTV module 28 is configured to analyze the response message to determine whether data elements in one or more of the network-specific fields has been altered from the specific data elements populated in the authorization message by the interchange network 16. If the PTV module 28 determines that data elements in the one or more network-specific fields have been altered (e.g., do not match the specific data elements), the interchange network 16 may send a payment transaction denial message to the sender (e.g., the merchant 12) indicating that the payment transaction is denied. If the PTV module 28 determines that one or more network-specific fields have not been improperly altered (e.g., match the specific data elements), the interchange network 16 may forward the response message on to the sender (e.g., the merchant 12 and/or the issuer 18) indicating that the payment transaction is validated for approval/acceptance.

The above-described process, as broadly illustrated in FIG. 5, will now be described in more detail. As was previously noted, transaction messages are digital messages generated by entities within the payment network system 10 and used to convey financial transaction data representative of payment transactions. Transaction messages are generally formatted according to a standardized format. For example, many transaction messages are formatted according to the ISO 8583 format, which defines a plurality of standard fields for the data elements included within transaction messages. In a given transaction message, each of such fields may be populated with data elements associated with the associated payment transaction. These fields (and data elements populated therein) can be used by the various entities of the payment network system 10 to verify, authorize, and settle the payment transactions with which the transaction messages are associated.

Commonly, transaction messages will comprise three primary types of fields: a message type indicator (“MTI”) field, a bitmap field, and data element fields. The MTI field of a transaction message is a field populated with a 4-digit MTI that is used to indicate the general functionality of the transaction message. For instance, MTIs may indicate (1) the overall purpose of the transaction message, (2) how the transaction message should flow within the payment network system 10, and (3) the source of the transaction message. As an example, an MTI having a value of “0100” indicates that the transaction message is a point-of-sale authorization message (e.g., a “0100” authorization) originating from a merchant 12. In contrast, an MTI having a value of “0110” indicates that the transaction message is a response message (e.g., a “0110” response) originating from the issuer 18 in response to a “0100” authorization. Although the above examples include only authorization messages (e.g., “0100” authorizations) and response messages (e.g., “0110” responses), it should be understood that embodiments of the present invention may be used to analyze generally any type of transaction message.

The bitmap field of a transaction message is a field populated with a data value (generally a binary or hexadecimal value) that is indicative of those data elements that are populated in the data element fields of the transaction message (the data element fields are discussed further below). In more detail, transaction messages formatted according to ISO 8583 generally include (64), (128), or (192) data element fields that can each include data elements representative of various types of information related to an associated payment transaction. A bitmap data value for such a transaction message can be configured to indicate which of the data elements within the (64), (128), or (192) data element fields are populated with data. As such, the bitmap field of a transaction message can provide an indication as to which data element fields are populated with data elements, and which data element fields are unpopulated (i.e., blank).

Finally, the data elements fields of a transaction message include data elements relevant to the associated payment transaction. As indicated above with respect to the bitmap field, the transaction message may include (64), (128), or (192) data element fields, with each field configured to be populated with one or more data elements relevant to the associated payment transaction. In some instances, certain data element fields may include sub-fields, which can each be populated with data elements. The following are examples of data element fields and associated data elements for a transaction message. Data element field “2” of a transaction message may include a data element in the form of the primary account number (PAN), which may be the sixteen-digit number of the payment card (e.g., of the cardholder's 22 credit or debit card) used to initiate the payment transaction. Data element field “4” may include the monetary amount (e.g., in U.S. Dollars) of the payment transaction. Data elements “12” and “13” may include the local time and date, respectively, of when the payment transaction was initiated. Data element “18” may include a data element indicative of the merchant 12 (e.g., merchant type and/or merchant identifier) at which the payment transaction was initiated. In sum, as described in the examples above, data element fields of a transaction message are configured to hold information relevant to an associated payment transaction, with such information used to facilitate processing and settling of the payment transaction.

For a transaction message in the form of an authorization message (e.g., a “0100” authorization), the data elements included within the data element fields are generally populated by the merchant 12 upon initiation of the associated payment transaction (e.g., upon the cardholder 22 swiping his/her card at the merchant's 12 point-of-sale terminal). In some embodiments, however, certain data element fields of an authorization message (and other transaction messages) are not configured to be populated by the merchant 12 but are, instead, populated downstream in the payment network system 10. For example, in some embodiments, only the interchange network 16 may be configured to populate certain data element fields (i.e., network-specific fields) in transaction messages. For example, the interchange network 16 may perform certain fraud analyses with respect to payment transactions so as to determine whether such payment transactions are likely valid or potentially fraudulent. Based on such fraud analyses, the interchange network 16 may itself populate the network-specific fields in the transaction messages, such that the transaction messages include an indication of validity or potential fraud that may be associated with the payment transactions.

As a specific example, data element field “48” of a transaction message formatted according to ISO 8583 is generally considered to be a network-specific field that is configured to be populated only by the interchange network 16. This data element field “48” (or an associated sub-field or sub-element) is intended to be left unpopulated (i.e., blank) until the interchange network 16 populates the data element field with a data element indicative of certain fraud characteristics of the payment transaction. The following sub-fields (referred to as a “sub-element” below) are exemplary data element sub-fields included within data element field “48,” and which may be populated with data elements by the interchange network 16:
Sub-element “75” (Fraud Scoring Data);
Sub-element “71” (On-behalf [OB] Services);
Sub-element “55” (Merchant Fraud Scoring Data);
Sub-element “51” (Merchant On-behalf [OB] Services);
Sub-element “56” (Security Services Additional Data for Issuers); and
Sub-element “57” (Security Services Additional Data for Acquirer).

Embodiments of the present invention provide for the validation of payment transactions by analyzing network-specific fields within transaction messages generated for such payment transactions. More particularly, the interchange network 16, including the PTV module 28 described above, may analyze network-specific fields (or sub-fields/sub-elements) within transaction messages to determine whether associated payment transactions are valid or fraudulent. For example, upon the initiation of a payment transaction by a cardholder 22 at a merchant 12, the merchant 12 will generate a transaction message in the form of an “0100” authorization and will send the “0100” authorization on to the interchange network 16 (e.g., via the acquirer 14). Upon receiving the “0100” authorization, the interchange network 16, and specifically the PTV module 28 of the interchange network 16, can analyze the network-specific fields within the “0100” authorization to determine whether the transaction message is valid or potentially fraudulent.

Specifically, the PTV module 28 may execute a validation routine to analyze whether one or more of the network-specific fields within the “0100” authorization is populated or unpopulated. As described above, network-specific fields of a certain transaction message should only be populated by the interchange network 16. Thus, based on the analyses of the network-specific fields of a transaction message, the PTV module 28 can determine whether the associated payment transaction is valid or potentially fraudulent. For instance, if a transaction message in the form of a “0100” authorization is received from a merchant 12 (and/or from the acquirer 14) with one or more network-specific fields pre-populated, the PTV module 28 may determine that the transaction message is associated with a potentially fraudulent payment transaction. Specifically, the transaction message may have been generated by a fraudulent actor and sent to the interchange network 16. In contrast, if the transaction message is received from a merchant 12 (and/or from the acquirer 14) with the one or more network-specific fields unpopulated, the PTV module 28 may determine that the transaction message is associated with a valid payment transaction.

As a specific example, the PTV module 28 can run a validation routine to analyze data element field “48” of the “0100” authorization, which is a network-specific field, to determine whether the data element field “48” is unpopulated or is populated with a data element. If the data element field “48” is determined to be populated, the PTV module 28 may determine that the transaction message is associated with a potentially fraudulent payment transaction. As such, the interchange network 16, and particularly the PTV module 28, may generate and send a denial message to the merchant 12 so that the merchant 12 can deny/decline the payment transaction. (In some embodiments, the interchange network 12 may simply decline to further process the payment transaction, in which case the payment transaction will not be completed and, thus, denied). In contrast, if the data element field “48” is determined to be unpopulated (i.e., blank), the PTV module 28 may determine that the transaction message is associated with a valid payment transaction. As such, the interchange network 16 may populate the data element field “48” with an appropriate data element and send the resulting transaction message (i.e., the “0100” authorization) to the issuer 18 for further processing of the payment transaction. For example, the interchange network 16 may populate the data element field “48” with a specific data element having value of “800,” which may be indicative of the payment transaction having a low-risk or acceptable fraud score.

Upon the issuer 18 receiving the “0100” authorization and verifying the payment transaction, the issuer 18 will generate a second transaction message in the form of a response message (i.e., a “0110” response). The “0110” response will be transmitted to the interchange network 16 and then to the merchant 12 for purposes of approving or denying the payment transaction. In some embodiments, however, the interchange network 16, and particularly the PTV module 28, may analyze the “0110” response for validity or potential fraud. In particular, the PTV module 28 may run a validation routine to analyze the network-specific fields within the “0110” response to determine if any of the data elements included within such network-specific fields have been changed or have otherwise been modified from the specific data elements populated into the “0100” authorization by the interchange network 16. If the PTV module 28 determines that any of the network-specific fields were changed, such a determination may be an indication that the transaction message was fraudulently altered between the issuer 18 and the interchange network 16.

As an example, it was previously discussed that the interchange network 16 may populate the data element field “48” of the “0100” authorization with the specific data element of “800.” When the issuer 18 returns the “0110” response, the data element field “48,” which remains a network-specific field that should only be modified by the interchange network 16, should not have been changed from the “800” value. If the PTV module 28 analyzes the “0110” response from the issuer 18 and determines the that data element field “48” has been modified from the specific data element (e.g., a change in value from “800” to “300”), then the PTV module 28 may determine that the transaction message was altered between the issuer 18 and the interchange network 16. In such a case, the interchange network 16 may send a denial message to the merchant 12, informing the merchant 12 that the payment transaction should be declined. Alternatively, if the PTV module 28 determines the that data element field “48” in the “0110” response has not been modified from (i.e., matches) the specific data element populated into the “0100” authorization, then the PTV module 28 may determine that the payment transaction is likely valid. The interchange network 16 may, thus, transmit the “0110” response to the issuer 18 and/or to the merchant 12 so that the merchant 12 can authorize the payment transaction.

Although the above exemplary embodiments describe the PTV module 28 analyzing data element field “48” of transaction messages (e.g., “0100” authorizations and “0110” responses), it should be understood that embodiments may analyze generally any network-specific fields (or subfields) within transaction messages. In addition, as was described previously, the bitmap field of a transaction message can include data values that indicate whether or not certain data element fields are populated. As such, in some embodiments, instead of directly analyzing network-specific fields within the data element fields, the PTV module 28 may analyze the data values within the bitmap field to determine whether or not certain network-specific fields of the data element field for a given transaction message have been improperly populated or modified by an entity other than the interchange network 16. Thus, in some embodiments, to analyze whether network-specific fields of the data element fields of a transaction message have been improperly populated, the PTV module 28 of the interchange network 16 may perform a validation routine that includes analyzing the bitmap field of the transaction message, so as to determine whether or not one or more network-specific fields of the data element fields of the transaction message have been populated with data.

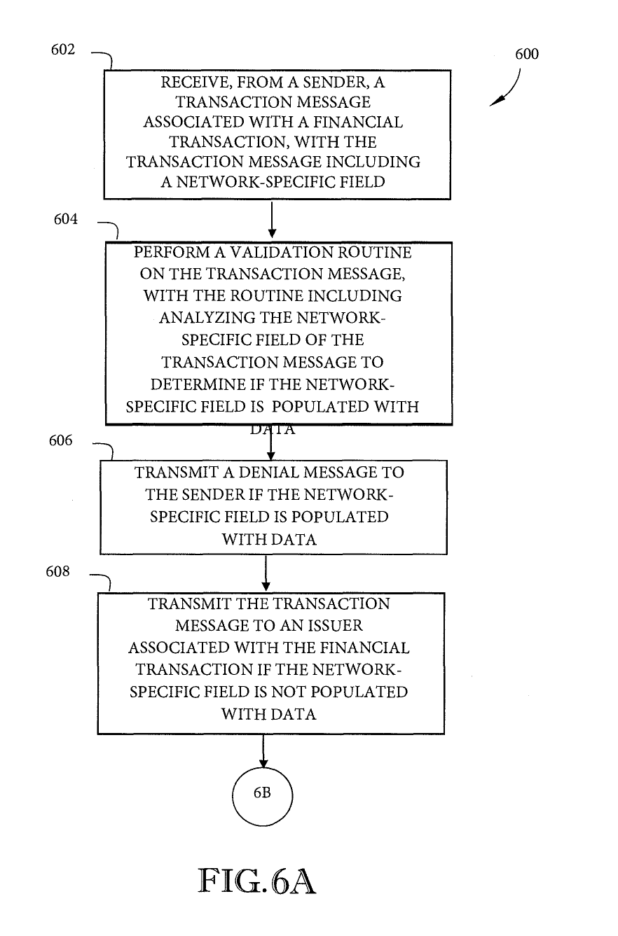

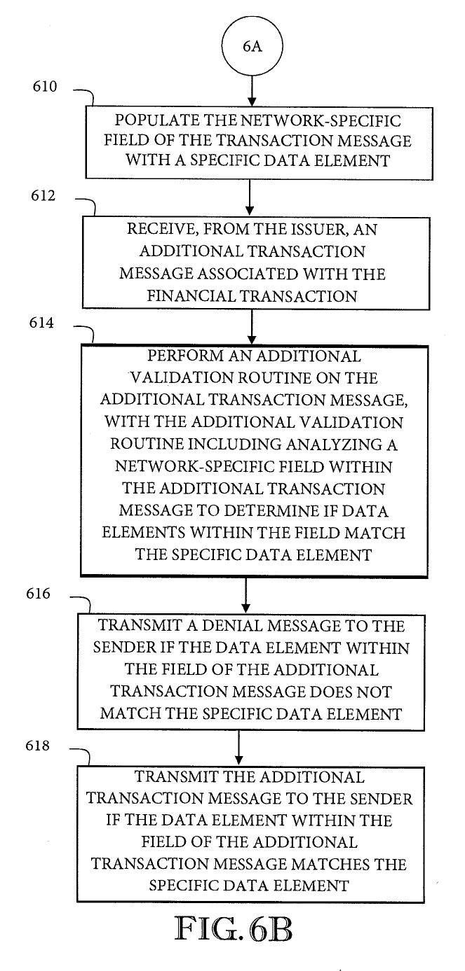

FIGS. 6A and 6B show flow charts of an exemplary method 600 for verifying a transaction message generated in response to a financial transaction (e.g., a payment transaction) initiated by a cardholder 22. In the example embodiment, the method 600 may be implemented by the PTV module 28, which was described above.

In the exemplary embodiment, the method 600, as illustrated in FIG. 6A includes Step 602 comprised of receiving, from a sender (e.g., the merchant 12), a transaction message (e.g., a “0100” authorization) associated with a financial transaction, such as a payment transaction discussed above. The transaction message may include a plurality of data element fields, with at least one of such data element fields being a network-specific field (e.g., data element field “48”) configured to be populated with data elements by the interchange network 16. A Step 604 includes performing a validation routine on the transaction message, with the validation routine including analyzing the network-specific field of the transaction message to determine if the network-specific field is populated with data. A Step 606 includes transmitting a denial message to the sender (e.g., the merchant 12) if the network-specific field of the transaction message is populated with data. A Step 608 includes transmitting the transaction message to an issuer associated with the financial transaction if the network-specific field of the transaction message is not populated with data.

In further embodiments, the method 600 may include an additional Step 610 of populating the one or more network-specific fields in the transaction message with specific data elements. In some embodiments, the Step 610 may be performed prior to the transaction message being transmitted to the issuer in Step 608. The method 600 may, in some embodiments, include a Step 612 of receiving, from the issuer, an additional transaction authorization message (e.g., a “0110” response) associated with the financial transaction. A Step 614 may include performing an additional validation routine on the additional transaction message, with the additional validation routine including analyzing one or more network-specific fields within the additional transaction message to determine if data elements included within the network-specific field matches the specific data element populated in Step 610. A Step 616 includes transmitting a denial message to the sender if the data elements included within the network-specific field of the additional transaction message do not match the specific data element. A Step 618 includes transmitting the additional transaction message to the sender if the data element included within the network-specific field matches the specific data elements.

It is noted that the computer-implemented method 600 may include more, fewer, or alternative operations, including those discussed elsewhere herein. Furthermore, any steps, actions, functions, operations, and the like recited herein may be performed in the order shown in the figures and/or described above, or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present invention.

A computer-readable storage media or medium comprising a non-transitory medium may include an executable computer program stored thereon. The computer program preferably instructs one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are illustrative only, and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above described memory types are examples only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory” “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A financial transaction verification system for a payment network, said financial transaction verification system comprising:
a memory device for storing data; and
a processor communicatively coupled to said memory device, said processor programmed to:
receive, from a sender, a transaction message associated with a financial transaction, wherein the transaction message comprises a plurality of data element fields, and wherein at least one of the data element fields is a network-specific field configured to be populated by an interchange network of the payment network;
perform a validation routine on the transaction message, wherein the validation routine includes analyzing the network-specific field of the transaction message to determine if the network-specific field is populated with data; and
deny the financial transaction by transmitting a denial message to the sender if the network-specific field of the transaction message is populated with data, or validate the financial transaction by transmitting the transaction message to an issuer associated with the financial transaction if the network-specific field of the transaction message is not populated with data.

2. The system in accordance with claim 1, wherein the processor is further programmed to populate the network-specific field of the transaction message with a specific data element.

3. The system in accordance with claim 2, wherein the transaction message is a first transaction message, and wherein the processor is further configured to:
receive, from the issuer, a second transaction message, wherein the second transaction message comprises a plurality of data element fields, and wherein at least one of the data element fields is a network-specific field;
perform a validation routine on the second transaction message, wherein the validation routine includes analyzing the network-specific field of the second transaction message to determine if the network-specific field is populated with a data element that matches the specific data element; and
deny the financial transaction by transmitting a denial message to the sender if the data element in the network-specific field of the second transaction message does not match the specific data element.

4. The system in accordance with claim 3, wherein the processor is further configured to validate the financial transaction by transmitting the second transaction message to the sender if the data element in the network-specific field of the second transaction message matches the specific data element.

5. The system in accordance with claim 4, wherein the second transaction message is a response message generated in response to the financial transaction.

6. The system in accordance with claim 1, wherein the transaction message is an authorization message associated with financial transaction.

7. The system in accordance with claim 6, wherein the transaction message is formatted according to an ISO 8583 format.

8. The system in accordance with claim 7, wherein the network-specific field is data element field 48.

9. The system in accordance with claim 7, wherein the network-specific field is a subfield of a data element field of the transaction message.

10. The system in accordance with claim 7, wherein the step of performing the validation routine on the transaction message includes analyzing a bitmap field of the transaction message, wherein the determination of whether the network-specific field is populated with data may be made based on the analysis of the bitmap field.

11. A computer-implemented method for verifying a financial transaction conducted over a payment network, said method comprising the steps of:
receiving, from a sender, a transaction message associated with the financial transaction, wherein the transaction message comprises a plurality of data element fields, and wherein at least one of the data element fields is a network-specific field configured to be populated by an interchange network of the payment network;
performing a validation routine on the transaction message, wherein the validation routine includes analyzing the network-specific field of the transaction message to determine if the network-specific field is populated with data; and
denying the financial transaction by transmitting a denial message to the sender if the network-specific field of the transaction message is populated with data, or validating the financial transaction by transmitting the transaction message to an issuer associated with the financial transaction if the network-specific field of the transaction message is not populated with data.

12. The computer-implemented method in accordance with claim 11, further comprising the step of populating the network-specific field of the transaction message with a specific data element.

13. The computer-implemented method in accordance with claim 12, wherein the transaction message is a first transaction message, and further comprising the steps of:
receiving, from the issuer, a second transaction message, wherein the second transaction message comprises a plurality of data element fields, and wherein at least one of the data element fields is a network-specific field;
performing a validation routine on the second transaction message, wherein the validation routine includes analyzing the network-specific field of the second transaction message to determine if the network-specific field is populated with a data element that matches the specific data element; and
denying the financial transaction by transmitting a denial message to the sender if the data element in the network-specific field of the second transaction message does not match the specific data element.

14. The computer-implemented method in accordance with claim 11, wherein the transaction message is an authorization message associated with the financial transaction.

15. The computer-implemented method in accordance with claim 11, wherein the financial transaction is a payment-card transaction initiated by a cardholder at the sender.

16. One or more non-transitory computer-readable storage media having computer-executable instructions for verifying a financial transaction conducted over a payment network stored thereon, wherein when executed by at least one processor the computer-executable instructions cause the processor to:
receive, from a sender, a transaction message associated with a financial transaction, wherein the transaction message comprises a plurality of data element fields, and wherein at least one of the data element fields is a network-specific field configured to be populated by an interchange network of the payment network;
perform a validation routine on the transaction message, wherein the validation routine includes analyzing the network-specific field of the transaction message to determine if the network-specific field is populated with data; and
deny the financial transaction by transmitting a denial message to the sender if the network-specific field of the transaction message is populated with data, or validate the financial transaction by transmitting the transaction message to an issuer associated with the financial transaction if the network-specific field of the transaction message is not populated with data.

17. The non-transitory computer-readable storage media in accordance with claim 16, wherein the computer-executable instructions further cause the processor to populate the network-specific field of the transaction message with a specific data element.

18. The non-transitory computer-readable storage media in accordance with claim 17, wherein the transaction message is a first transaction message, and wherein the computer-executable instructions further cause the processor to:
receive, from the issuer, a second transaction message, wherein the second transaction message comprises a plurality of data element fields, and wherein at least one of the data element fields is a network-specific field;
perform a validation routine on the second transaction message, wherein the validation routine includes analyzing the network-specific field of the second transaction message to determine if the network-specific field is populated with a data element that matches the specific data element; and
deny the financial transaction by transmitting a denial message to the sender if the data element in the network-specific field of the second transaction message does not match the specific data element.

19. The non-transitory computer-readable storage media in accordance with claim 16, wherein the transaction message is an authorization message associated with the financial transaction.

20. The non-transitory computer-readable storage media in accordance with claim 16, wherein the financial transaction is a payment-card transaction initiated by a cardholder at the sender.
